(19) United States
(12) Patent Application Publication
(10) Pub. No.: US 2025/0027648 A1
(43) Pub. Date: Jan. 23, 2025

(54) GAS TAP WITH SAFETY VALVE FOR A GAS COOKING APPLIANCE

(71) Applicant: COPRECI, S.COOP., ARETXABALETA (ES)

(72) Inventors: Imanol ARRIOLA-BENGOA UNZUETA, ERENTXUN (ES); Iñigo PEÑAGARICANO BADIOLA, URRETXU (ES)

(21) Appl. No.: 18/778,238

(22) Filed: Jul. 19, 2024

(30) Foreign Application Priority Data
Jul. 21, 2023 (EP) 23382761.7

(51) Int. Cl. F23N 1/00

(52) U.S. Cl. CPC F23N 1/007; F23N 2235/24; F23N 2241/08

(57) ABSTRACT

A gas tap with a safety valve for a gas cooking appliance. According to one aspect the gas tap includes a body with an inlet conduit, a gas outlet conduit, and a housing. A regulating disc having a regulation opening is arranged in the housing of the body. An actuator element is housed in the body and is configured to open the safety valve by means of its rotation. A gear is coupled to an output shaft of a motor and is configured to transmit the movement of the motor to the regulating disc. The actuator element is a wheel comprising a plurality of teeth, the actuator element being part of the gear.

### CROSS-REFERENCE TO RELATED APPLICATIONS

This application relates to and claims the benefit and priority to European Application No. EP23382761.7, filed Jul. 21, 2023, of which is incorporated herein by reference in its entirety.

### FIELD

The present invention relates to gas taps with a safety valve for gas cooking appliances and to gas appliances incorporating said gas taps.

### BACKGROUND

Gas taps with a safety valve that regulate gas flow and open the safety valve by means of the rotation of a motor are known. For example JP380357B2 relates to a gas tap with a safety valve comprising a body comprising a gas inlet conduit fluidically connected with the safety valve, a gas outlet conduit, a housing fluidically connected with the safety valve and with said outlet conduit, and a regulating disc arranged in said housing and configured to regulate the gas flow. The gas tap comprises a motor and a gear system arranged outside the body, and a transmission shaft arranged at the outlet of the gear system and introducing adapted movement of the motor in the body. The gas tap comprises a cam coupled to said transmission shaft, said cam being configured to act on the safety valve and open it by means of its rotation. The regulating disc is also coupled to the transmission shaft.

### SUMMARY

The object of the invention is to provide a gas tap with a safety valve for a gas cooking appliance and a gas cooking appliance incorporating said gas tap, as defined in the claims.

A first aspect of the invention relates to a gas tap with a safety valve for a gas cooking appliance.

The gas tap with a safety valve comprises a body comprising a gas inlet conduit fluidically connected with the safety valve, at least one gas outlet conduit, and a housing fluidically connected with the safety valve and with said at least one outlet conduit. Furthermore the housing comprises a contact surface comprising at least one outlet hole fluidically connected with said at least one outlet conduit.

The gas tap comprises a regulating disc comprising at least one regulation opening and arranged in the housing of the body over the contact surface, the regulating disc being configured to regulate, by means of its rotation, the incoming gas flow from the safety valve to said at least one outlet conduit.

The gas tap also comprises an actuator element housed in the body and configured to open the safety valve by means of its rotation.

Furthermore, the gas tap comprises a motor comprising an output shaft, and a gear coupled to the shaft of the motor and configured to transmit the movement of the motor to the regulating disc.

The actuator element is a wheel comprising a plurality of teeth, the actuator element being part of the gear. In that sense, the actuator element is an at least partially toothed wheel that is part of the gear that transmits the rotation of the shaft of the motor to the regulating disc. At the same time, the actuator element is configured to open the safety valve by means of its rotation. The actuator element thereby performs a dual function, and a more compact actuation mechanism of the tap with fewer parts can be obtained.

A second aspect of the invention relates to a gas cooking appliance comprising at least one gas tap like the one described in the first aspect of the invention.

These and other advantages and features of the invention will become apparent in view of the figures and the detailed description of the invention.

### BRIEF DESCRIPTION OF THE DRAWINGS

FIG. 1 shows a perspective view of a preferred embodiment of the gas tap of the invention.

FIG. 2 shows a second perspective view of the gas tap of FIG. 1 without the cover.

FIG. 3 shows a first section view of the gas tap of FIG. 1.

FIG. 4 shows a second section view of the gas tap of FIG. 1.

FIG. 5 shows a first partial view of the gas tap of FIG. 1.

FIG. 6 shows a second partial view of the gas tap of FIG. 1.

FIG. 7 shows the actuator element of the gas tap of FIG. 1.

FIG. 8 shows the regulating disc of the gas tap of FIG. 1.

FIG. 9 shows the body of the gas tap of FIG. 1.

FIG. 10 shows the worm screw of the gas tap of FIG. 1.

### DETAILED DESCRIPTION

A first aspect of the invention relates to a gas tap 1 with a safety valve 20 for a gas cooking appliance.

The gas tap 1 of the invention comprises a body 10 comprising a gas inlet conduit 11 fluidically connected with the safety valve 20, at least one gas outlet conduit 12, 13, and a housing 14 fluidically connected with the safety valve 20 and with said at least one outlet conduit 12, 13. The housing 14 comprises a contact surface 140 comprising at least one outlet hole 120, 130 fluidically connected with said at least one outlet conduit 12, 13. Preferably the gas tap 1 comprises between one and three outlet conduits.

Preferably the safety valve 20 is a normally closed solenoid valve housed in a safety conduit 19 of the body 10, said safety conduit 19 being connected with the gas inlet conduit 11. Said safety valve 20 comprises a plug 21, said plug 21 being configured to be displaced between a closed position in which it is arranged on a seating 18 of the safety conduit 19, preventing the gas flow, and a passage position in which the plug 21 is separated from the seating 18, allowing the gas flow from the inlet conduit 11 to the housing 14 through a passage opening 180 connecting the safety conduit 19 with the housing 14 of the body 10. In that sense, when the plug 21 is arranged in the closed position, the safety valve 20 is considered to be closed, whereas when the plug 21 is arranged in the passage position, the safety valve 20 is considered to be open. The safety valve 20 also comprises a spring 22 which causes the plug 21 to be in the closed position. The initial opening of the safety valve 20 is performed by mechanically pushing the plug element 21, separating it from the seating 18, and preferably, during a brief predetermined period of time, the safety valve 20 is electronically powered to keep the safety valve 20 open. Once said period has passed, while the burner associated with the gas tap 1 is on, the corresponding thermocouple keeps the safety valve energized and, accordingly, the plug 21 in the passage position.

The gas tap 1 also comprises a regulating disc 30 comprising at least one regulation opening 31a, 31b. The regulating disc 30 is arranged in the housing 14 of the body 10 over the contact surface 140. The regulating disc 30 is configured to regulate, by means of rotating same, the incoming gas flow from the safety valve 20 to said at least one outlet conduit 12, 13. Preferably, the regulating disc 30 comprises a series of regulation openings 31a, 31b per outlet conduit 12, 13 which allow regulating the gas flow between the housing 14 and the corresponding outlet conduit 12, 13 by means of the rotation of the regulating disc 30. Alternatively, the regulating disc may comprise a single regulation opening per outlet conduit. The regulation of the gas flow occurs when at least one regulation opening 31a, 31b and the corresponding outlet hole 120, 130 are arranged fluidically connected.

Furthermore, the gas tap 1 comprises a motor 80, preferably a BLDC motor, comprising an output shaft 81. A stepper motor or any other low torque motor could also be used.

The gas tap 1 also comprises a gear coupled to the shaft 81 of the motor 80 and configured to transmit the movement of the motor 80 to the regulating disc 30.

The gas tap 1 comprises an actuator element 40 housed in the body 10 and configured to open the safety valve 20 by means of its rotation. Furthermore, the actuator element 40 is a wheel comprising a plurality of teeth 41, the actuator element 40 being part of the gear. Preferably the plurality of teeth 41 are arranged on at least part of the perimeter of the actuator element 40.

In that sense, the actuator element 40 is an at least partially toothed wheel which, in addition to being part of the gear that transmits the rotation of the shaft 81 of the motor 80 to the regulating disc 30, is also configured to open the safety valve 20 by means of its rotation. The actuator element 40 thereby performs a dual function, and an actuation mechanism of the gas tap 1 with fewer parts, and which is therefore simpler and more compact, can be obtained.

In that sense, the gas tap 1 of the invention is a motor-driven gas tap 1 which, by means of the rotation of the motor 80, can on one hand mechanically open the safety valve 20, and on the other hand regulate the gas flow from the inlet conduit 11 to said at least one outlet conduit 12, 13.

Preferably the motor 80 is arranged outside the housing 14 of the body 10, i.e., the motor 80 is arranged outside the area through which the gas circulates. The fact that the motor 80 is arranged outside the housing 14, and therefore outside the gas circuit, prevents the gas tap from having to overcome testing required by law for gas taps in which there is electricity inside a housing through which the gas circulates. Furthermore, the arrangement of the motor 80 outside the housing 14 of the body 10 facilitates the tightness of the gas tap 1, given that in the event that the motor is inside the housing of the body, the cavity to be isolated would increase considerably, and furthermore a system would have to be designed to assure the isolation of the power cables and control of the motor.

Preferably the gear comprises a worm screw 60, said worm screw 60 being coupled to the shaft 81 of the motor 80, and said worm screw 60 engaging with the teeth 41 of the actuator element 40. In that sense, the rotation axis 600 of the worm screw 60 is arranged perpendicular with respect to the rotation axis 402 of the actuator element 40. Preferably the body 10 comprises an inlet hole which allows introducing the worm screw 60 inside the body 10. The worm screw 60 thereby comprises a first end arranged outside the body 10, said first end being coupled to the shaft 81 of the motor, and the rest of the worm screw 60 being housed in the body 10. Preferably the gas tap 1 comprises a lip seal 56 arranged surrounding the worm screw 60 and supported against the body 10 to seal the inlet hole and thus maintain the tightness of said inlet port. The tightness required is obtained with the lip seal 56, exercising a friction force on the worm screw 60 that is considerably less than force that would be exerted on said worm screw in the case of using an O-ring commonly used in motor-driven gas taps in which the motor is arranged outside the housing of the body. Taking into account that to obtain a cost-effective solution, it would be of interest to use a motor 80 with a low output torque, the fact that the friction force to be exerted by the lip seal 56 is small is a great advantage.

This type of gear known as a “worm gear” allows reducing the output speed of the motor 80 by increasing the torque in the transmission. A motor 80 with a low output torque can thereby be used, obtaining as a result of the type of gear the torque necessary in the actuator element 40 to cause the opening of the safety valve 20. The motors with a low output torque are usually less expensive, so the use of this type of gear, also in addition to the dual function of the actuator element 40 which allows using fewer parts, makes the gas tap 1 of the invention a less expensive and simpler solution. Furthermore, this type of “worm screw-worm screw wheel” gear requires less space and achieves a greater reduction of speed-increase of output torque than in a gear with parallel shafts, such that the solution of the invention requires a lower number of parts in the transmission system, obtaining a less complex gas tap and facilitating the manufacture, assembly, and operation thereof.

In the worm gear type gears, radial stresses which can cause an imbalance in the movement of the rotor/stator of the motor coupled to the worm screw can be generated, causing the operation of the motor to be less efficient and being able to cause gas leaks in the lip seal 56 located between the body 10 and the worm screw 60. To that end, to minimize these possible radial displacements, preferably the gas tap 1 comprises at least one bushing 54, 55 with little clearance surrounding a part of the worm screw 60, a bushing 54 preferably being arranged after the lip seal 56. Said at least one bushing 54, 55 is housed in a corresponding retention housing of the body 10, such that said at least one bushing 54, 55 keeps the worm screw 60 centered and prevents radial displacement thereof. More preferably, the gas tap 1 comprises a first bushing 54 arranged in a first part 61 of the worm screw 60 and a second bushing 55 arranged in a second part 62 of the worm screw 60, the toothed part 63 of the worm screw 60 being arranged between the first part 61 and the second part 62. Additionally, the gas tap 1 may comprise an axial stop 57 arranged in the body 1, the worm screw 60 comprising a notch 65 cooperating with said axial stop 57 such that the possible axial displacements of the worm screw 60 are also minimized.

Preferably the actuator element 40 comprises a protrusion 42 configured to act indirectly on the plug element 21 of the safety valve 20. Preferably the protrusion 42 is arranged on the perimeter of the actuator element 40 and protrudes radially with respect to the perimeter of said actuator element 40.

Preferably the protrusion 42 can also be used to define a zero position of the regulating disc 30. To that end the protrusion 42 can cooperate with an abutment wall of the body 10 such that when said zero position is to be determined, the actuator element 40 is rotated in a search for zero direction, determining the zero position when the protrusion 42 abuts with the abutment wall that prevents the actuator element 40 from being able to continue rotating in said direction.

Furthermore, preferably the gas tap 1 comprises a lever 70 arranged in the housing 14 and rotationally fixed to the body 10 by means of a rotation shaft 73. The lever 70 is configured to act on the plug element 21 of the safety valve 20 when the rotation of the actuator element 40 causes the protrusion 42 to act on the lever 70. The lever 70 comprises a first radial prolongation 71 configured to cooperate with the actuator element 40, and a second radial prolongation 72 configured to cooperate with the safety valve 20, the rotation shaft 73 being arranged between both radial prolongations 71, 72. In that sense, the second radial prolongation 72 of the lever 70 is configured to act on the plug element 21 of the safety valve 20, opening said safety valve 20 when the protrusion 42 of the actuator element 40 pushes the first radial prolongation 71 of the lever 70. In that sense, the lever 70 is configured to rotate between a standby position and a pushing position in which the second radial prolongation 72 of the lever 70 goes through the passage opening 180, thus separating the plug 21 from the seating 18, allowing the passage of gas from the inlet conduit 11 to the housing 14 through the passage opening 180. The lever 70 amplifies the force transmitted by the actuator element 40 to the plug 21 such that its use as an intermediate element allows exerting the force needed to open the safety valve 20 with a lower torque of the actuator element 40 than if said actuator element 40 were to act directly on the plug 21. The use of the lever 70 thereby causes the torque required of the motor 80 to be able to open the safety valve 20 to be lower. The at least one regulation opening 31a, 31b of the regulating disc 30 is arranged such that when the protrusion 42 of the actuator element 40 is arranged in angular positions of the circular sector in which said protrusion 42 acts on the lever 70, said at least one regulation opening 31a, 31b does not coincide with the at least one outlet hole 120, 130, such that it is ensured that there will be no gas flow while the protrusion 42 acts on the lever 70, i.e., while the plug 21 of the safety valve 20 is operated mechanically, such that in the event of a malfunction, if the actuator element 40 were to be blocked in an angular position in which the plug 21 is operated mechanically by the lever 70, it is ensured that there will be no gas leak.

Preferably the regulating disc 30 is coupled to the actuator element 40 such that both parts rotate integrally, the actuator element 40 being what directly transmits the rotation to the regulating disc 30. To that end, preferably the actuator element 40 comprises a central protrusion 43 and the regulating disc 30 comprises a central hole 32 with a shape complementary to the central protrusion 43 of the actuator element 40, the central protrusion 43 being housed in the central hole 32 such that both parts rotate integrally. Alternatively, the regulating disc can be integrated in the actuator element itself.

Preferably the body 10 comprises a central hole 16 in which a shaft 51 is arranged, and the central protrusion 43 of the actuator element comprises a central hole 430, the shaft 51 going through said central hole 430 such that the actuator element 40 is configured to rotate with respect to said shaft 51.

Preferably the actuator element 40 comprises at least one pressure element 44 that protrudes with respect to the surface 400 of the actuator element 40 which is arranged facing the regulating disc 30, said at least one pressure element 44 being configured to press the regulating disc 30 against the contact surface 140. In that sense, the actuator element 40 also has the function of ensuring proper support of the regulating disc 30 over the contact surface 140 of the housing 14.

Preferably the gas tap 1 comprises a sealing gasket 50 housed in the contact surface 140 surrounding the at least one outlet hole 120, 130, the regulating disc 30 being arranged in a supported manner, pressing on said sealing gasket 50, the sealing gasket 50 ensuring the tightness between the regulating disc 30 and the contact surface 140, such that it is assured that there will only be gas flow to the at least one outlet conduit 12, 13 when at least one regulation opening 31a, 31b and the corresponding outlet hole 120, 130 are arranged fluidically connected.

Preferably the actuator element 40 is axially retained by means of a spring 52 that pushes the actuator element 40 at one of its ends, the other end of the spring 52 being supported in a cover 15 attached to the body 10 that closes the housing 14 of the body 10 in a leak-tight manner. Preferably the gas tap 1 comprises a lower support part 58 manufactured in a low friction material, for example nylon, which is arranged between the actuator element 40 and the spring 52. Preferably the gas tap 1 also comprises an upper support part 57 which is arranged between the cover 15 and the spring 52.

Preferably the gas tap 1 comprises a second sealing gasket 53 arranged between the body 10 and the cover 15.

A second aspect of the invention relates to a gas cooking appliance comprising at least one gas tap 1 like the one described in the first aspect of the invention.

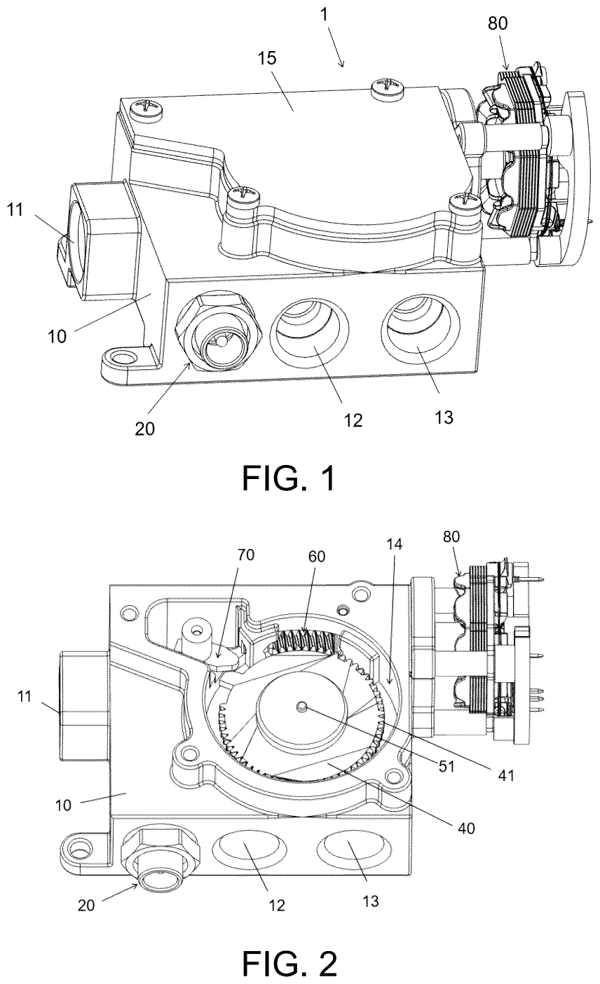

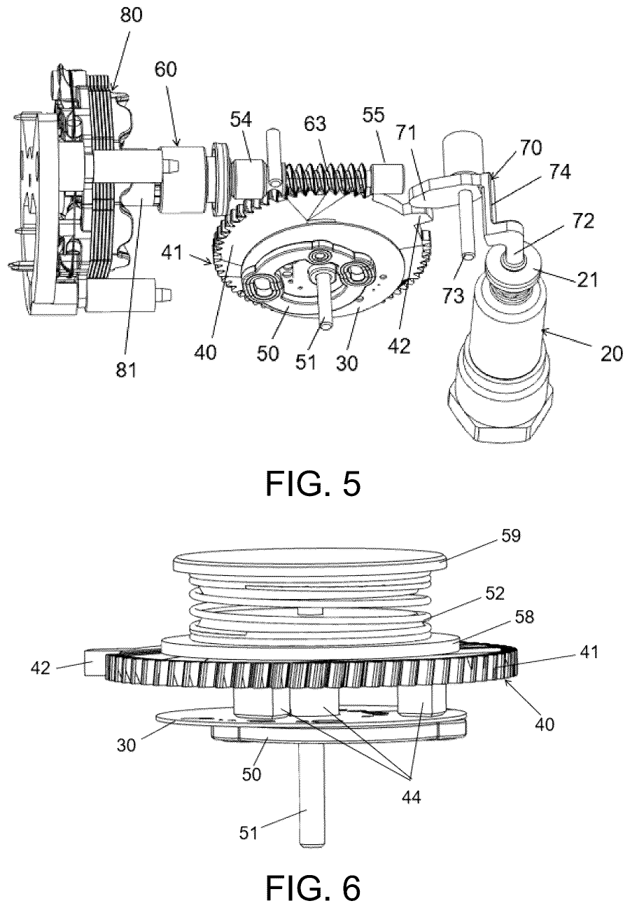

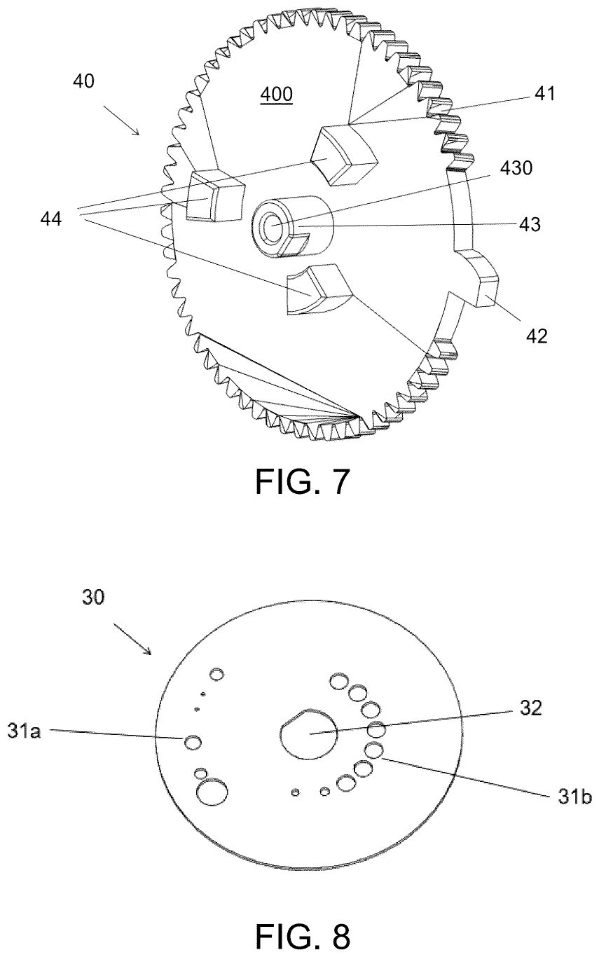

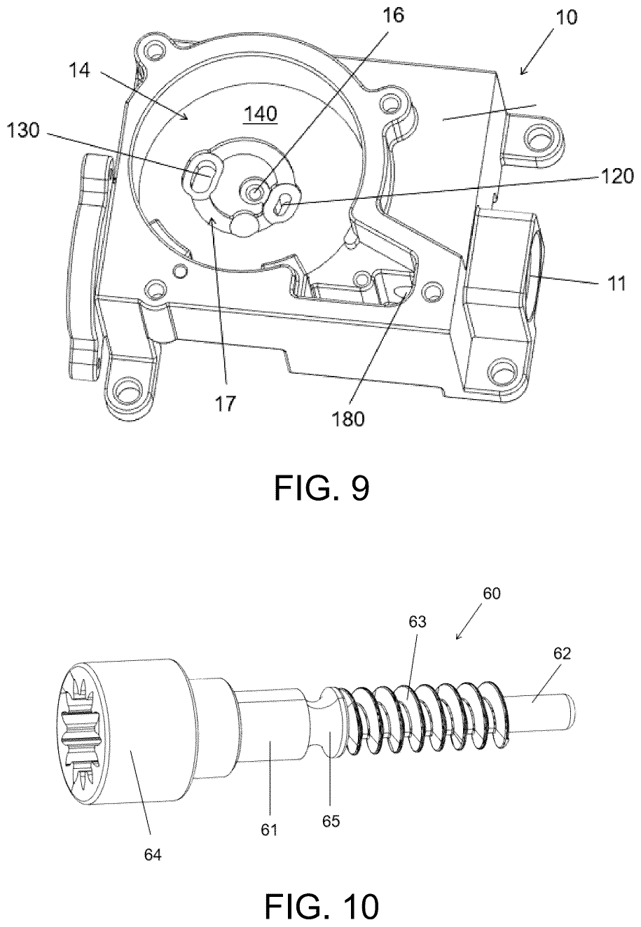

FIGS. 1 to 9 show a gas tap 1 according to a preferred embodiment of the invention.

In the preferred embodiment the gas tap 1 comprises a body 10 comprising a safety conduit 19 in which a safety valve 20 is arranged, and a gas inlet conduit 11 fluidically connected with said safety conduit 19. The body 10 also comprises two gas outlet conduits 12, 13, and a housing 14 fluidically connected with the safety conduit 19 and with said outlet conduits 12, 13. The housing 14 comprises a contact surface 140 comprising two outlet holes 120, 130, each outlet hole 120, 130 being fluidically connected with the outlet conduit 12, 13 corresponding. Furthermore, the safety conduit 19 comprises a seating 18 comprising a passage opening 180 connecting the safety conduit 19 with the housing 14 of the body 10.

In this preferred embodiment the safety valve 20 is a normally closed solenoid valve. The safety valve 20 comprises a plug 21 configured to be displaced between a closed position in which the plug 21 is arranged on the seating 18 of the safety conduit 19, preventing the gas flow, and a passage position in which the plug 21 is separated from the seating 18, allowing the gas flow from the inlet conduit 11 to the housing 14 through a passage opening 180. The safety valve 20 comprises a spring 22 which causes the plug 21 to be in the closed position. The initial opening of the safety valve 20 is performed by mechanically pushing the plug element 21, separating it from the seating 18 and during a brief predetermined period of time, the safety valve 20 is electronically powered to keep the safety valve 20 open. Once said period has passed, while the burner associated with the gas tap is on, the corresponding thermocouple keeps the safety valve 20 energized and, accordingly, the plug 21 in the passage position.

The gas tap 1 of the preferred embodiment also comprises a regulating disc 30 arranged in the housing 14 of the body 10 over the contact surface 140. The regulating disc 30 is configured to regulate, by means of its rotation, the incoming gas flow from the inlet conduit 11, through the safety valve 20, to the outlet conduits 12, 13. To that end, the regulating disc 30 comprises a first series of regulation openings 31a to regulate the gas flow from the housing 14 of the body 10 to the first outlet conduit 12 through the first outlet hole 120, and a second series of regulation openings 31b to regulate the gas flow from the housing 14 of the body 10 to the second outlet conduit 13 through the second outlet hole 130. The openings of the series of regulation openings 31a, 31b form two rows with a radial shape having a different radius, the radius of the first series of regulation openings 31a being larger than the second series of regulation openings 31b. To obtain the gas flow rate required in the outlet conduits 12, 13, a specific number of openings of the series of regulation openings 31a, 31b of the regulating disc 30 overlap the outlet holes 120, 130.

The gas tap 1 of the preferred embodiment also comprises a BLDC motor 80 arranged outside the housing 14 of the body 10. The motor 80 comprises an output shaft 81.

The gas tap 1 also comprises a gear coupled to the shaft 81 of the motor 80 and configured to transmit the movement of the motor 80 to the regulating disc 30.

The gas tap 1 of the preferred embodiment also comprises an actuator element 40 housed in the body 10 and configured to open the safety valve 20 by means of its rotation. The actuator element 40 is a wheel comprising a plurality of teeth 41 arranged on part of the perimeter of the actuator element 40, the actuator element 40 being part of the gear. In that sense, the actuator element 40 is a partially toothed wheel which, in addition to being part of the gear that transmits the rotation of the shaft 81 of the motor 80 to the regulating disc 30, is also configured to open the safety valve 20 by means of its rotation.

In the preferred embodiment the gear is a “worm gear”. In that sense, the gear comprises a worm screw 60 coupled to the shaft 81 of the motor 80, said worm screw 60 engaging with the teeth 41 of the actuator element 40.

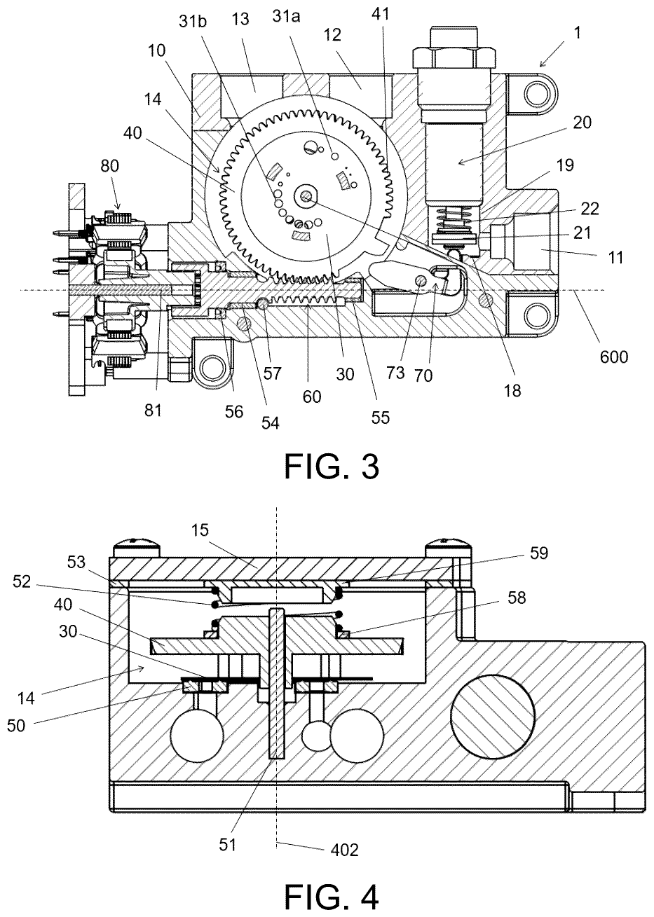

In this preferred embodiment the body 10 comprises an inlet hole which allows introducing the worm screw 60 inside the body 10. The worm screw 60 thereby comprises a first end arranged outside the body 10, said first end being coupled to the shaft 81 of the motor, and the rest of the worm screw 60 being housed in the body 10, as observed in detail in FIG. 3. The gas tap 1 comprises a lip seal 56 arranged surrounding the worm screw 60 and supported against the body 10 to seal the inlet hole and thus maintain the tightness of said inlet port.

Furthermore, as shown in detail in FIG. 3, the gas tap 1 of the preferred embodiment comprises a first bushing 54 arranged after the lip seal 56 and surrounding a first part 61 of the worm screw 60, and a second bushing 54 arranged surrounding a second part 62 of the worm screw 60, the toothed part 63 of the worm screw 60 being arranged between the first part 61 and the second part 62. Said bushings 54, 55 are housed in a respective retention housing of the body 10 such that said bushings 54, 55 keep the worm screw 60 centered and prevent radial displacement thereof.

In the preferred embodiment of the gas tap 1, the actuator element 40 comprises a protrusion 42 arranged on the perimeter of the actuator element 40 and protruding radially with respect to the perimeter of said actuator element 40. The protrusion 42 is configured to act indirectly on the plug element 21 of the safety valve 20.

Furthermore, the gas tap 1 of the preferred embodiment comprises a lever 70 arranged in the housing 14 and rotationally fixed to the body 10 by means of a rotation shaft 73. The lever 70 is configured to act on the plug element 21 of the safety valve 20 when the rotation of the actuator element 40 causes the protrusion 42 to act on the lever 70. The lever 70 comprises a first radial prolongation 71 configured to cooperate with the actuator element 40 and a second radial prolongation 72 configured to cooperate with the safety valve 20, the rotation shaft 73 being arranged between both radial prolongations 71, 72. In that sense, the second radial prolongation 72 of the lever 70 is configured to act on the plug element 21 of the safety valve 20, mechanically opening said safety valve 20 when the protrusion 42 of the actuator element 40 pushes the first radial prolongation 71 of the lever 70.

In this preferred embodiment the lever 70 comprises a rectangular prism-shaped central part 74, the first radial prolongation 71 extending perpendicularly from the proximity of one of the ends of the central part 74, and the second radial prolongation 72 extending perpendicularly from the proximity of the opposite end of the central part 74. The first radial prolongation 71 is arranged perpendicular to the second radial prolongation 72. The first radial prolongation comprises a hole that the rotation shaft 73 goes through.

As mentioned above, a worm gear allows reducing the speed by considerably increasing the output torque of the motor 80. Furthermore, the use of the lever 70 as an intermediate element between the actuator element 40 and the plug 21 also increases the force exerted on said plug 21. Therefore, as a result of the type of gear used and the use of the lever 70 as an intermediate element, a motor 80 with a low output torque, and therefore inexpensive, can be used to actuate the gas tap 1.

In the preferred embodiment of the gas tap 1, the regulating disc 30 is coupled to the actuator element 40 such that both parts rotate integrally, the actuator element 40 being what directly transmits the rotation to the regulating disc 30. To that end, the actuator element 40 comprises a central protrusion 43 and the regulating disc 30 comprises a central hole 32 with a shape complementary to the central protrusion 43 of the actuator element 40, the central protrusion 43 being housed in the central hole 32 such that both parts rotate integrally. The body 10 comprises a central hole 16 in which a shaft 51 is arranged, and the central protrusion 43 of the actuator element comprises a central hole 430, said central hole 430 going through the shaft 51 such that the actuator element 40 is configured to rotate with respect to said shaft 51.

Furthermore, in the preferred embodiment of the gas tap 1 the actuator element 40 comprises three pressure elements 44 which are prolonged perpendicularly from the surface 400 of the actuator element 40 which is arranged facing the regulating disc 30, said pressure elements 44 being configured to press the regulating disc 30 against the contact surface 140.

The gas tap 1 of the preferred embodiment comprises a sealing gasket 50 housed in the contact surface 140 surrounding the outlet hole 120, 130, the regulating disc 30 being arranged in a supported manner, pressing on said sealing gasket 50.

The gas tap 1 of the preferred embodiment also comprises a cover 15 attached to the body 10 that closes the housing 14 of the body 10 in a leak-tight manner. As shown in detail in FIG. 4, the actuator element 40 is axially retained by means of a spring 52 that pushes the actuator element 40 at one of its ends, the other end of the spring 52 being supported in the cover 15. The gas tap 1 comprises a lower support part 58 manufactured in a low friction material, for example nylon, which is arranged between the actuator element 40 and the spring 52, and an upper support part 57 which is arranged between the cover 15 and the spring 52.

The gas tap 1 of the preferred embodiment comprises a second sealing gasket 53 arranged between the body 10 and the cover 15.

Embodiments are also disclosed in the clauses that follow.

Clause 1. Gas tap with a safety valve (20) for a gas cooking appliance, comprising
a body (10) comprising
a gas inlet conduit (11) fluidically connected with the safety valve (20),
at least one gas outlet conduit (12, 13), and
a housing (14) fluidically connected with the safety valve (20) and with said at least one outlet conduit (12, 13), the housing (14) comprising a contact surface (140) comprising at least one outlet hole (120, 130) fluidically connected with said at least one outlet conduit (12, 13),
a regulating disc (30) comprising at least one regulation opening and arranged in the housing (14) of the body (10) over the contact surface (140), the regulating disc (30) being configured to regulate, by means of its rotation, the incoming gas flow from the safety valve (20) to said at least one outlet conduit (12, 13),
an actuator element (40) housed in the body (10) and configured to open the safety valve (20) by means of its rotation,
a motor (80) comprising an output shaft (81), and
a gear coupled to the shaft (81) of the motor (80) and configured to transmit the movement of the motor (80) to the regulating disc (30),
the actuator element (40) is a wheel comprising a plurality of teeth (41), the actuator element (40) being part of the gear.

Clause 2. The gas tap according to clause 1, wherein the motor (80) is arranged outside the housing (14) of the body (10).

Clause 3. The gas tap according to clause 1 or 2, wherein the motor (80) is a BLDC motor.

Clause 4. The gas tap according to any of clauses 1 to 3, wherein the gear comprises a worm screw (60), said worm screw (60) being coupled to the shaft (81) of the motor (80), and said worm screw (60) engaging with the teeth (41) of the actuator element (40).

Clause 5. The gas tap according to clause 4, comprising at least one bushing (54, 55) surrounding a part of the worm screw (60), said at least one bushing being housed in a retention housing for retaining the body (10) such that said at least one bushing (54, 55) keeps the worm screw (60) centered and prevents radial displacement thereof.

Clause 6. The gas tap according to clause 5, comprising a first bushing (54) arranged in a first part (61) of the worm screw (60) and a second bushing (55) arranged in a second part (62) of the worm screw (60), the toothed part (63) of the worm screw (60) being arranged between the first part (61) and the second part (62).

Clause 7. The gas tap according to any of clauses 1 to 6, wherein the actuator element (40) comprises a protrusion (42) configured to act indirectly on a plug element (21) of the safety valve (20).

Clause 8. The gas tap according to clause 7, comprising a lever (70) arranged in the housing (14) and rotationally fixed to the body (10), a second radial prolongation (72) of the lever (70) being configured to act on the plug element (21) of the safety valve (20), opening said safety valve (20) when the protrusion (42) of the actuator element (40) pushes a first radial prolongation (71) of the lever (70).

Clause 9. The gas tap according to any of clauses 1 to 8, wherein the regulating disc (30) is coupled to the actuator element (40) such that both parts rotate integrally.

Clause 10. The gas tap according to clause 9, wherein the actuator element (40) comprises a central protrusion (43) and the regulating disc (30) comprises a central hole (32) with a shape complementary to the central protrusion (43) of the actuator element (40), the central protrusion (43) being housed in the central hole (32) such that both parts rotate integrally.

Clause 11. The gas tap according to clause 9 or 10, wherein the actuator element (40) comprises at least one pressure element (44) that protrudes with respect to the surface (400) of the actuator element (40) which is arranged facing to the regulating disc (30), said at least one pressure element (44) being configured to press the regulating disc (30) against the contact surface (140).

Clause 12. The gas tap according to any of clauses 1 to 11, comprising a sealing gasket (50) housed in the contact surface (140) surrounding the at least one outlet hole (120, 130), the regulating disc (30) being arranged in a supported manner, pressing on said sealing gasket (50).

Clause 13. The gas tap according to any of clauses 1 to 8, wherein the regulating disc (30) is integrated in the actuator element (40) itself.

Clause 14. The gas tap according to any of clauses 1 to 13, wherein the actuator element (40) is axially retained by means of a spring (52) that pushes the actuator element (40) at one of its ends, the other end of the spring (52) being supported in a cover (15) attached to the body (10) that closes the housing (14) of the body (10) in a leak-tight manner.

Clause 15. A gas cooking appliance comprising at least one gas tap (1) according to any of clauses 1 to 14.

What is claimed is:

1. A gas tap for a gas cooking appliance, the gas tap comprising
a safety valve having a plug element;
a body including:
a gas inlet conduit fluidically connected with the safety valve;
a gas outlet conduit fluidically connectable with the safety valve: and
a housing fluidically connected with the safety valve via a passage opening, the housing including a contact surface having an outlet hole fluidically connected with the outlet conduit;
the plug element being moveable to allow or prevent gas flow from the gas inlet conduit to the gas outlet conduit;
a regulating disc including a regulation opening and arranged in the housing of the body over the contact surface, the regulating disc being configured to rotate to regulate gas flow through the regulation opening into the outlet conduit;
a rotatable wheel located in the body housing and including teeth arranged along at least a portion of a periphery of the wheel, the wheel being mechanically coupled to the plug element of the safety valve to cause the plug element to be pushed to allow gas flow through the safety valve during a rotation of the wheel, the wheel also being mechanically coupled to the regulating disc such that when the wheel rotates so does the regulating disc;
a motor having an output shaft; and
a gear coupled to the output shaft of the motor and configured to transmit movement of the motor to cause the wheel to rotate.

2. The gas tap according to claim 1, wherein the motor is arranged outside the housing of the body.

3. The gas tap according to claim 1, wherein the motor is a BLDC motor.

4. The gas tap according to claim 1, wherein the gear includes a worm screw engaging with the teeth of the wheel.

5. The gas tap according to claim 4, further comprising a first bushing retained in the body and surrounding a first non-toothed part of the worm screw, the first bushing configured to keep the worm screw centered with the output shaft of the motor and to prevents radial displacement thereof.

6. The gas tap according to claim 5, further comprising a second bushing retained in the body and surrounding a second non-toothed part of the worm screw, a toothed part of the worm screw being arranged between the first and second non-toothed parts.

7. The gas tap according to claim 1, wherein the wheel comprises a protrusion configured to act indirectly on the plug element of the safety valve.

8. The gas tap according to claim 7, comprising a lever arranged in the housing and rotationally fixed to the body, the lever having first and second prolongations, the second prolongation being configured to push on the plug element upon the protrusion of the wheel being pushed by the first radial prolongation.

9. The gas tap according to claim 1, wherein the regulating disc is coupled to the wheel such that both parts rotate integrally.

10. The gas tap according to claim 9, wherein the wheel includes a central protrusion and the regulating disc includes a central hole with a non-circular shape complementary to an external shape of the central protrusion, the central protrusion being housed in the central hole.

11. The gas tap according to claim 1, further comprising at least one pressure element protruding from a surface of the wheel which is arranged facing a surface of the regulating disc, the at least one pressure element being configured to press the regulating disc against the contact surface of the housing.

12. The gas tap according to claim 1, further comprising a sealing gasket on the contact surface of the housing surrounding the outlet hole, the regulating disc pressing on the sealing gasket.

13. The gas tap according to claim 1, wherein the regulating disc is integrated in the wheel.

14. The gas tap according to claim 1, wherein the wheel is axially retained by a spring that has a first end that pushes against a side of the wheel and a second end that pushed against a cover attached to the body that closes the housing of the body in a leak-tight manner.

15. The gas tap according to claim 4, wherein the worm screw rotates about a first axis and the wheel rotates about a second axis that is perpendicular to the first axis.

16. The gas tap according to claim 1, wherein the safety valve is a solenoid valve.

17. A gas cooking appliance comprising:
a gas burner having a gas inlet; and
a gas tap according to claim 1, wherein the gas outlet conduit of the body is fluidly coupled to the gas inlet of the gas burner.

18. The gas cooking appliance according to claim 17, wherein the safety valve is a solenoid valve, the gas cooking appliance further comprising a thermocouple located adjacent the gas burner that is configured to generate current to power the solenoid valve.
